(19) United States
(12) Patent Application Publication
(10) Pub. No.: US 2022/0259450 A1
(43) Pub. Date: Aug. 18, 2022

(54) COLOR CHANGING AQUEOUS INK

(71) Applicant: Société BIC, Clichy (FR)

(72) Inventors: Auorore Sauvage, GY Les Nonains (FR); Alexander Bourque, Montevrain (FR)

(21) Appl. No.: 17/618,242

(22) PCT Filed: Jun. 9, 2020
(86) PCT No.: PCT/EP2020/065981

§ 371 Date: Dec. 10, 2021

(30) Foreign Application Priority Data
Jun. 12, 2019 (FR) 19305747.8

(51) Int. Cl. C09D 11/50; C09D 11/17; C09D 11/20; C09D 11/18

(52) U.S. Cl. CPC C09D 11/50; C09D 11/18; C09D 11/20; C09D 11/17

(57) ABSTRACT

There is a non-thermochromic irreversible color changing aqueous writing ink including core-shell dye microparticles and a coloring agent, in which the core of the core-shell dye microparticles includes an organic solvent immiscible with water and at least one dye soluble in the organic solvent and the shell includes a resin component. There also is a writing instrument containing it and the process of preparation of this ink.

### CROSS REFERENCE TO RELATED APPLICATIONS

This application is a National Stage Application of International Application No PCT/EP2020/065981, filed on Jun. 9, 2020, now published as WO2020/249564, and which claims priority from EP19305747.8, filed on Jun. 12, 2019, the entire contents of both of which are incorporated herein by reference.

### FIELD OF THE DISCLOSURE

The present disclosure concerns non-thermochromic color changing aqueous writing inks. The color of this type of ink can be changed after writing by the use of an eraser, in particular by the use of a rubber eraser.

### DESCRIPTION OF THE RELATED ART

Thermochromic inks can change color by the use of the heat generated by the friction of the eraser as described in EP2802631. However, this change of color is reversible with low temperature and therefore the previous color of the draw lines can be regenerated unwantedly. Moreover their use is not possible in countries where the temperature is often high or often very low because color and change of color depends on temperature. Furthermore the colors obtained by the use of these inks are not very vivid and are not resistant to UV-light because of the use of leuco-dyes.

Inks erasable by peeling (such as by a rubber eraser) are known in the art such as in U.S. Pat. No. 5,661,197. However, the dyes used in the polymer-encapsulated colorant disclosed in this document have to be soluble in the monomer intended for its encapsulation. Moreover the monomer has to be insoluble in water in order to perform emulsion polymerization. Furthermore the polymer-encapsulated colorant particles have a very low diameter (between 25 to 1000 nm) and therefore will penetrate deep into the paper fibers and be difficult to peel off by mechanical action. Finally this document does not describe or suggest that the ink can change color instead of being erased by the use of an eraser.

Therefore there is a need to find new color changing non-thermochromic inks the color of which can be changed by mechanical action, avoiding an unwanted color return or an unwanted color loss due to a change in temperature, having high color intensity and multiple choices of colors.

### SUMMARY OF THE DISCLOSURE

The inventors have surprisingly found that the use of core-shell dye microparticles, in which the core comprises an organic solvent immiscible with water and at least one dye soluble in the organic solvent and the shell includes a resin component, can resolve the above-mentioned problem and have all the desired above-mentioned advantages. They are also resistant to UV light in order to avoid discoloration under the sun over time.

An additional advantage of the disclosure is to enable to include in the ink composition solid particles, such as core-shell dye microparticles, in particular, of a specific size, without clogging the pen point.

The present disclosure therefore concerns a non-thermochromic color changing aqueous writing ink comprising core-shell dye microparticles and a coloring agent, wherein the core of the core-shell dye microparticles comprises an organic solvent immiscible with water and at least one dye soluble in the organic solvent and the shell includes a resin component, in particular an irreversible color changing aqueous writing ink.

More specifically the present disclosure concerns a non-thermochromic irreversible color changing aqueous writing ink comprising core-shell dye microparticles and a coloring agent, wherein the core of the core-shell dye microparticles comprises an organic solvent immiscible with water and at least one dye soluble in the organic solvent and the shell includes a resin component, wherein the color changing, in particular from a first color into a second color, is essentially by removing the core-shell dye microparticles. Hereinafter, a detailed description of the present disclosure will be given. The specific embodiments are meant to better illustrate the present disclosure, however, it should be understood that the present disclosure is not limited to these specific embodiments.

### DETAILED DESCRIPTION OF THE DISCLOSURE

In the sense of the present disclosure, the expression “comprising a” should be understood as being synonymous with “comprising at least one”.

In the sense of the present disclosure, the expressions “between . . . and . . . ” or “ranging from . . . to . . . ” should be understood as including the values of the limits. The ink according to the present disclosure is a non-thermochromic ink. For the purposes of the present disclosure, the term “non-thermochromic ink” is intended to mean any ink which will not be erased or will not change its color due to a change in temperature such as an increase or a decrease.

For the purposes of the present disclosure, the term “color-changing ink” is intended to mean any ink which can change color after writing. After writing, the written mark made with the ink according to the present the disclosure can change from a first color into a second color. In particular, the term “color-changing ink” is intended to mean that the color of the ink is changing into another color, but not becoming colorless. The written mark obtained, in particular on cellulosic fiber paper such as paper (printer paper for example) and cardboard paper, by this ink can therefore change color just after writing and also even a few days after writing.

The color of the written mark before the color change will depend on the color of the dye contained in the core-shell dye microparticles and on the color of the coloring agent contained in the ink.

After the color change, since the core-shell dye microparticles are removed, in particular by peeling, the color of the written mark obtained will depend only on the color of the coloring agent contained in the ink.

In particular, the color changing ink is color changing by removing the core-shell dye microparticles. More specifically the written mark made with the ink is color changing by peeling (such as by mechanical friction), in particular by the use of an eraser such as a rubber, more specifically a rubber which is made of a blend of ethylene-propylene-diene monomer rubber and polypropylene.

Hence, the initial color (first color) of the ink composition after writing on a substrate can be changed into a second color by removing part of the written mark by peeling. In particular, the first and second colors are different which mean that they can be distinguished from each other by the human eye.

The ink composition according to the present disclosure is “peelable” in that part of the written mark made with the ink can be removed from the surface of a substrate, in particular on cellulosic fiber paper such as paper (printer paper for example) and cardboard paper, in particular for some period of time after formation without damaging the substrate.

The ink according to the present disclosure is specifically irreversibly color-changing. It is therefore an irreversible color-changing ink. Once the color has been changed (from a first color into a second color), it is not possible to change it again and in particular to go back to the previous color (initial color also called first color).

In particular, the ink composition according to the disclosure is non-erasable. In particular, the ink is “non-erasable” in that, even if the ink can change color from a first to a second color, it is non-erasable, as after writing, a written mark remains on the substrate and therefore it cannot be erased after writing, although the core-shell dye microparticles can be removed.

For the purposes of the present disclosure, the term “peelable ink” is intended to mean any ink which can be peeled (or rubbed) after writing, more specifically by the use of an eraser, in particular by the use of a rubber eraser.

The written mark obtained, in particular on cellulosic fibers paper such as paper (printer paper for example) and cardboard, by this ink can therefore be peeled just after writing such as less than 10 seconds after writing, even a few days after writing, and also even one month after writing, to change the initial color of the writing in another color (second color).

The ink according to the present disclosure is a writing ink. For the purposes of the present disclosure, the term “writing ink” is intended to mean any ink which is intended to be used in a writing instrument, in particular in a pen such as a ball-pen. A writing ink should not be confused with a printing ink which is used in printing machines and which does not have the same technical constraints and thus the same specifications. Indeed, a writing ink must not contain solid particles of which the size is greater than the channels of the writing instrument, in order to avoid blocking them, which would inevitably lead to writing being irreversibly stopped. It must also dry sufficiently rapidly to avoid smudging the writing medium. It must also avoid the problems of migration (bleeding) over time. Thus, the ink according to the present disclosure will be suitable for the writing instrument for which it is intended, in particular for a pen such as a ball-pen.

More specifically, the aqueous non-thermochromic color-changing writing ink composition of the disclosure enables obtaining vivid colors of written marks once applied on porous substrates (also named porous surfaces). For the purposes of the present disclosure, the term “porous substrate” is intended to mean substrate that contains pores. The porous substrates have empty spaces or pores that allow external matter, like ink, to penetrate into the substrate.

Specifically, the ink composition according to the disclosure comprises solid particles, such as core-shell dye microparticles, in particular above a specific size, without clogging the pen point. More specifically, the adherence of the composition according to the disclosure is sufficient to avoid having it being removed inadvertently from the surface on which it had been applied, but allows removing it efficiently when specifically rubbed, in particular with an eraser or friction body, in particular from porous substrate.

Moreover, the ink composition according to the disclosure shows good stability, in particular with regards to the dispersion of the microparticles; more specifically no sedimentation phenomenon is to be observed.

The ink according to the present disclosure contains core-shell dye microparticles. For the purposes of the present disclosure, the term “core-shell dye microparticles” are microscale particles whose core and shell are different in composition and the core contains a dye. Therefore these particles have the function of a coloring agent in the ink according to the present disclosure. More specifically, these particles have the color of the dyes contained therein.

More specifically the core-shell dye microparticles of the ink according to the present disclosure have a mean diameter in intensity D50 measured by dynamic light scattering such as Malvern Mastersizer 3000E in the range 1.5-20 μm, more specifically in the range 2-20 μm.

More specifically the core-shell dye microparticles of the ink according to the present disclosure have a mean diameter in intensity D50 measured by dynamic light scattering such as Malvern Mastersizer 3000E in the range 4-20 μm, still more specifically in the range 4-15 μm, more specifically in the range 4-12 μm, still more specifically in the range 4-8 μm.

Indeed if the mean diameter D50 is lower than 1.5 μm or lower than 2 μm, there is a high probability that the microparticles will penetrate deep into the paper fibers and will be difficult to eliminate and therefore there will be no change in color.

Moreover if the mean diameter D50 is higher than 20 μm, there is a high probability that there will be a clogging of the point of the ballpoint pen and this ink will not be usable with such a writing instrument.

The core-shell dye microparticles can have different forms, but more specifically they are spherical and therefore the microparticles are microspheres, even more specifically the microparticles are microcapsules. In an advantageous manner, the amount of the core-shell dye microparticles in the ink according to the present disclosure is within the range 5-40 weight %, more specifically 10-35 weight %, even more specifically 15-30 weight % based on the total weight of the ink.

Ink compositions of the present disclosure enable surprisingly to obtain core-shell microcapsules of a diameter mean diameter in intensity D50 above a specific size, sufficient to prevent those from penetrating into the spaces or pores of the porous substrate (such as paper) and at the same time, without clogging the pen point.

Without wishing to be bound by a theory, the core-shell microcapsules present in the ink composition of the present disclosure are believed to be supple enough to avoid these from clogging the pen point, on contrary to harder particles.

The core of the microparticles comprises an organic solvent immiscible with water and at least one dye soluble in the organic solvent, and more specifically insoluble in water. For the purposes of the present disclosure, the term “an organic solvent immiscible with water” is intended to mean any organic solvent having a solubility in water lower than 30 g/L. The organic solvent of the microparticle's core is therefore immiscible with water and more specifically selected in the group consisting of petroleum solvents such as paraffinic alkanes, esters such as isopropyl myristate and octyl acetate, ethers such as dibutyl ether, aryl ethers and arylalkyl ethers, glycol ethers such as 2-phenoxyethanol, 2-phenoxypropanol, fatty alcohols such as 1-octadecanol, amines, terpenes, naphthenic solvent such as alkylated naphthalene, halogenated solvents such as trichloromethane, chlorinated diphenyl, chlorinated paraffin and monochlorobenzene, ketones such as heptadecan-9-one, cottonseed oil, groundnut oil, silicone oil, tricresyl phosphate, partially hydrogenated terphenyls, alkylated diphenyls and mixture thereof, even more specifically it is selected in the group consisting of petroleum solvents such as paraffinic alkanes, esters such as isopropyl myristate and octyl acetate, ethers such as dibutyl ether, glycol ethers such as 2-phenoxyethanol, 2-phenoxypropanol, fatty alcohols such as 1-octadecanol, amines, terpenes, naphthenic solvent, halogenated solvents such as trichloromethane, chlorinated diphenyl, chlorinated paraffin and monochlorobenzene, ketones such as heptadecan-9-one and mixture thereof, still more specifically it is selected in the group consisting of isopropyl myristate, heptadecan-9-one, 1-octadecanol and mixture thereof, in particular it is 1-octadecanol.

More specifically the organic solvent content of the microparticle's core is in the range 75-98 weight % based on the total weight of the microparticle's core, even more specifically in the range 80-95 weight % based on the total weight of the microparticle's core, still more specifically in the range 85-90 weight % based on the total weight of the microparticle's core.

The microparticle's core also contains at least one dye, in particular a mixture of dyes, which is soluble in the organic solvent. More specifically the dye is insoluble in water. For the purposes of the present disclosure, the term “dye” should be understood as meaning colored, mineral or organic particles of any form, which are soluble in the medium in which they are solubilized, and which are intended to color the ink composition. The dyes usable in the ink of the present disclosure may be any dyes well-known to the skilled person, such as black, blue, red, green, violet, pink, turquoise, etc. dyes. In particular, the dyes usable in the ink according to the present disclosure may be alcohol-soluble dyes, oil-soluble dyes, direct dyes, acid dyes, basic dyes, metallized dyes and various salt-forming-type dyes. More particularly, the dyes may be selected from the group consisting of azoic dyes, triarylmethane dyes, phthalocyanine dyes, xanthene dyes, and mixtures thereof. The dye can be selected for example in the group consisting for Sudan Red 380, Sudan blue 670, Baso Red 546, Baso Blue 688, Sudan yellow 150, Baso Blue 645, Flexo Yellow 110, Flexo Blue 630, Oil Red 235, Morfast Yellow 101, Nitro Fast Yellow B, Macrolex Yellow 6 G, Solvent Yellow 14, 16, 21 and 36, Solvent Orange 45, 62, Solvent Red 1, 7, 8, 49, 119, and 125, Solvent Blue 5, 14, 25, 36 and 51 and Solvent Black 5 and 34 and mixtures thereof. The dye can belong to the solvent dye class such as: triphenylmethane compounds such as crystal violet, malachite green, diphenylmethane compounds such as 4,4-bis-dimethylaminobenzhydryl benzyl ether, N-2,4,5-trichlorophenylleucauramine N-halogenophenylleucauramine, N-β-naphthylleucauramine, N-2,4-dichlorophenylleucauramine, xanthene compounds such as rhodamine-β-anilinolactam, rhodamine-β-(p-nitroaniline)-lactam, rhodamine-β-(p-chloroaniline)-lactam, thiazine compounds such as N-benzoylleucomethylene blue, o-chlorobenzoylleucomethylene blue and p-nitrobenzoylleucomethylene blue, and spiropyran compounds such as 3-methyl-2-2′-spiro-bis-(benzo(f)-chromene). It can be any mixtures of these dyes.

More specifically, the dye content of the microparticle's core is in the range 2-25 weight % based on the total weight of the microparticle's core, even more specifically in the range 5-20 weight % based on the total weight of the microparticle's core, still more specifically in the range 10-15 weight based on the total weight of the microparticle's core.

The microparticle's core can contain other components well known by the one skilled in the art such as antioxidants, anti-UV agents, pH-adjustors and mixtures thereof. More specifically it does not contain any other components and consists of the organic solvent and at least one dye. Still more specifically it is at least one dye (in particular the mixture of dyes) contained in the core of the microparticle which will give the color to the microparticle. The shell of the microparticle includes a resin component which is more specifically insoluble in water. Even more specifically the precursor of the resin component (used during the process of preparation of the core-shell microparticle) is soluble in water.

The resin component can be selected in the group consisting of polymer of urethane resin, melamine resin, urea resin, benzoguanamine resin, phenol resin, epoxy resin, natural polymers such as sodium alginate, gelatin, cellulosic polymer such as ethylcellulose, hydroxypropylcellulose and mixture thereof, more specifically it is a melamine resin.

The shell can contain other components well known by the one skilled in the art such as a surfactant. More specifically it does not contain any coloring agent such as a dye or a pigment. Even more specifically the shell consists in the resin component only and therefore does not contain any other component. Still more specifically, the resin component is not a colored resin component and the shell can be colorless or even transparent.

The ink according to the present disclosure contains water as the solvent. More specifically the amount of water in the ink according to the present disclosure is comprised between 20-80 weight %, more specifically 30-70 weight % based on the total weight of the ink.

The aqueous ink according to the present disclosure contains a coloring agent. In particular, the coloring agent is not comprised in the core-shell dye microparticles. The coloring agent can be a dye or a pigment. The dye or pigment can be any dye or pigment known by the one skilled in the art and which can be used in aqueous writing inks. More specifically, the dye is not a thermochromic dye or a photochromic dye or a pressure sensitive dye. More specifically the coloring agent is a dye. In this case the ink is a dye-based ink. It thus comprises at least one dye. It may also comprise several dyes. The dyes usable in the ink according to the disclosure may be any dyes known by the one skilled in the art, such as yellow, black, blue, red, green, violet, pink, turquoise, etc. dyes. In particular, the dyes usable in the ink according to the present disclosure are water-soluble dyes, direct dyes, acid dyes, basic dyes, metallized dyes and various salt-forming type dyes, in particular acid dyes

Examples of acid dyes usable in the ink according to the present disclosure are as follow: Acid red 51, Acid red 52, Acid red 18, Acid Yellow 23, Acid blue 9.

In another embodiment, the coloring agent is a pigment known by the one skilled in the art. Examples of pigment include organic, inorganic and processed pigments. Thus the pigment may for example be an inorganic pigment such as a carbon black, ultramarine and titanium dioxide pigment, an organic pigment such as an azo-based pigment, phthalocyanine-based pigment, indigo pigment, thioindigo pigment, thren pigment, quinacridone-based pigment, anthraquinone-based pigment, thron-based pigment, diketopyrrolopyrrole-based pigment, dioxazine-based pigment, perylene-based pigment, perinone-based pigment and isoindolinone-based pigment, a metal pigment such as an aluminum powder or aluminum powder whose surface is treated with a colored resin, a metal gloss pigment, a metal pigment, a colloidal particle having a mean particle size of 5 to 30 nm selected from gold, silver, platinum and copper, a fluorescent pigment, light-storing pigment, pearlescent pigment, synthetic mica, glass flake, alumina and transparent film with a metal oxide such as titanium oxide, and the like.

More specifically the coloring agent content is in the range 0.01-30 weight %, even more specifically 0.05-25 weight % based on the total weight of the ink.

More specifically, the ink according to the present disclosure comprises a rheology modifying agent, in particular capable of generating a gelling effect, even more specifically selected in the group consisting of synthetic polymers (for example polyacrylic acids, polyvinyl alcohol, polyethylene oxide, polyvinylpyrrolidone, polyvinyl methyl ether, polyacrylamide and mixture thereof), cellulosic derivatives (such as cellulose nanofibers, hydroxyethyl cellulose, carboxymethylcellulose and mixture thereof), polysaccharides (such as xanthan gum, gum arabic, carrageenan (in particular kappa and/or iota carrageenan, more specifically iota carrageenan), guar gum, casein, gelatin, alginic acid and salts thereof (in particular sodium alginate), tragacanth gum, locust beam gum and mixture thereof), still more specifically selected in the group consisting of xanthan gum, gum arabic, carrageenan, cellulose nanofibers, polyvinylpyrrolidone, cellulosic derivatives such as hydroxyethylcellulose, carboxymethylcellulose, and mixture thereof, in particular selected in the group consisting of xanthan gum, polyvinylpyrrolidone and mixture thereof, more particularly it is xanthan gum.

More specifically the amount of the rheology modifying agent in the ink according to the present disclosure is comprised between 0.05-5 weight %, more specifically 0.1-3 weight %, even more specifically 0.2-2.5 weight %, based on the total weight of the ink.

The aqueous non-thermochromic writing ink according to the present disclosure can contain other additives known by the one skilled in the art to be usable in aqueous inks, more specifically selected in the group comprising water miscible solvents, anti-microbial agents, corrosion inhibitor agents, anti-foam agents, pH regulator agents, lubricants, coalescing agents, crosslinking agents, wetting agents, humectants, antioxidants, UV stabilizers, film-forming agents, dispersing agents, fungicides and mixture thereof.

More specifically the additive content of the ink according to the present disclosure is within the range 10-35 weight %, even more specifically 15-30 weight %, based on the total weight of the ink according to the present disclosure.

The ink according to the present disclosure can therefore more specifically contain at least a water miscible solvent such as polar solvents. More specifically the water miscible solvent can be selected in the group consisting of:
glycol such as ethylene glycol, diethylene glycol, triethylene glycol, polyethylene glycol, propylene glycol,
glycol ethers such as ethylene glycol monomethyl ether, ethylene glycol monoethyl ether, diethylene glycol monomethyl ether, diethylene glycol monoethyl ether, diethylene glycol monobutyl ether, dipropylene glycol monomethyl ether, dipropylene glycol monobutyl ether, dipropylene glycol monopropyl ether, tripropylene glycol monomethyl ether, and mixture thereof,
alcohols such as linear or branched alcohol in C₁-C₆ for example isopropanol, butanol, isobutanol, pentanol, benzyl alcohol, glycerin, diglycerin, polyglycerin and mixture thereof,
carbonate esters such as propylene carbonate, ethylene carbonate and mixture thereof,
lactame such as 2-pyrrolidone, N-methyl 2-pyrrolidone and mixture thereof,
ketones such as methylisobutylketone (MIBK), acetone, cyclohexanone and mixture thereof,
and mixtures thereof.

In an advantageous embodiment, the water miscible solvent is selected in the group consisting of glycol ethers or alcohols such as linear or branched alcohol in C₁-C₆ or lactame, and more specifically selected in the group consisting of glycerin, triethylene glycol, polyethylene glycol, 2-pyrrolidone, and mixture thereof, still more specifically it is glycerin.

More specifically, the water miscible solvent is present in the aqueous ink according to the present disclosure in an amount ranging from 5 to 50 weight %, even more specifically from 10 to 40 weight %, and even more specifically from 15 to 35 weight %, relative to the total weight of the aqueous ink.

The aqueous ink according to the present disclosure can contain an antimicrobial agent such as benzoic acid, sorbic acid, carbonic acid, zinc pyrrithione, sodium pyrrithione, sorbate, 2-bromo-2-nitropropane-1,3 diol (Bronopol® from Boots Company), isothiazolinones (ACTICIDE® from Thor), more specifically selected in the group consisting of 1,2-benzisothiazolin-3-one, 2-methyl-4-isothiazolin-3-one, and mixture thereof. More specifically, the antimicrobial agent is present in the aqueous ink according to the disclosure in an amount ranging from 0.01 to 1 weight %, even more specifically ranging from 0.05 to 0.5 weight %, relative to the total weight of the aqueous ink.

The aqueous ink according to the present disclosure may comprise a corrosion inhibitor, more specifically selected in the group consisting of dicyclohexylammonium nitrile, diisopropylammonium nitrile, saponins, tolytriazole, benzotriazole, and mixture thereof, even more specifically selected in the group consisting of tolytriazole, benzotriazole, and mixture thereof.

More specifically, the corrosion inhibitor is present in the aqueous ink of the disclosure in an amount ranging from 0.01 to 1 weight %, even more specifically ranging from 0.05 to 0.5 weight %, relative to the total weight of the aqueous ink.

The aqueous ink according to the present disclosure may comprise an antifoam agent, more specifically a polysiloxane-based antifoam agent, and even more specifically an aqueous emulsion of modified polysiloxane (such as MOUSSEX® from Synthron, TEGO® Foamex from Evonik).

More specifically, the antifoam agent is present in the aqueous ink according to the present disclosure in an amount ranging from 0.01 to 1.5 weight %, even more specifically from 0.10 to 1 weight %, relative to the total weight of the aqueous ink.

The aqueous ink according to the present disclosure may comprise a film-forming agent which allows the fixation of the microparticles on the paper and avoids therefore the change of color of the ink by simply brushing it with the fingers or another sheet of paper while being capable of color-changing by the use of a conventional eraser, such as a rubber eraser. It can be selected in the group consisting of polyvinylpyrrolidone, polyvinyl alcohol, an acrylic polymer, latex such as diene rubber such as a styrene-butadiene rubber, an acrylonitrile-butadiene rubber, a cis-1,4-polyisoprene rubber, and mixture thereof. More specifically, the film-forming agent is present in the aqueous ink according to the present disclosure in an amount ranging from 0.5 to 10 weight %, even more specifically from 1 to 7 weight %, relative to the total weight of the aqueous ink.

The aqueous ink according to the present disclosure may comprise a dispersing agent which is used for the stabilization of the microparticles in the ink in order to avoid the sedimentation, aggregation and maturation of the microparticles, such as fatty alcohols salts, fatty amines salts, polyurethanes, polyethers, polyacrylic salts, polyols.

More specifically, the dispersing agent is present in the aqueous ink according to the present disclosure in an amount ranging from 0.05 to 5 weight %, even more specifically from 0.1 to 3 weight %, relative to the total weight of the aqueous ink.

The aqueous ink according to the present disclosure may comprise other additives such as pH regulator agents, lubricants, coalescing agents, crosslinking agents, wetting agents, humectants, antioxidants, UV stabilizers, fungicides and mixture thereof. More specifically the other additive content of the ink according to the present disclosure is within the range 0.5-20 weight %, more specifically 1-15 weight %, based on the total weight of the ink according to the present disclosure.

The lubricants can be fatty acids, such as oleic acid and its derivatives, polyether modified silicone oils, thiophosphite triesters, phosphate derivatives such as phosphoric ester, phosphate monoester of polyoxyethylene alkyl ether or polyoxyethylene aryl ether, phosphate diester of polyoxyethylene alkyl ether.

The pH controlling agent can be ammonia, urea, monoethanolamine, diethanolamine, triethanolamine, alkali metal salts of phosphoric acid such as tripolyphosphate, sodium carbonate and hydroxides of alkali metals such as sodium hydroxide.

More specifically the ink according to the present disclosure does not contain any other microparticles or nanoparticles or resin particles (even colorless ones) than the core-shell dye microparticles.

In an advantageous embodiment the ink according to the present disclosure is a non-photochromic ink. For the purposes of the present disclosure, the term “non-photochromic ink” is intended to mean any ink which will not be erased or will not change its color due to a change in UV light such as an increase or a decrease.

More specifically, the aqueous ink composition, is not an emulsion, such as a water-in-oil or oil-in-water emulsion. More specifically, the composition according to the disclosure is essentially free of a solvent which is immiscible with water, in particular the ink composition does not comprise an organic solvent which is immiscible with water. According to this preferred embodiment, only the core of the microparticles comprises an organic solvent immiscible with water, in particular the rest of the ink composition does not comprise a solvent which is immiscible with water.

The ink composition according to the disclosure shows good stability, in particular with regards to the dispersion of the microparticles, more specifically no sedimentation phenomenon is to be observed.

The present disclosure concerns also a writing instrument, in particular a pen such as a ball-pen, a roller pen, a felt pen, even more specifically it is a ball pen, containing the non-thermochromic color changing aqueous writing ink according to the present disclosure.

More specifically the writing instrument according to the present disclosure contains a rubber, in particular located on the cap or on the non-writing end of the writing instrument, more particularly the rubber being made of a blend of ethylene-propylene-diene monomer rubber and polypropylene. More specifically the writing instrument according to the present disclosure comprises:
an axial barrel containing the non-thermochromic color changing aqueous writing ink according to the disclosure, and
a pen body which delivers the non-thermochromic color changing aqueous writing ink stored in the axial barrel, in particular as described in the present disclosure.

The present disclosure also concerns a process of preparation of the non-thermochromic color changing aqueous writing ink according to the present disclosure, in particular as described in the present disclosure, comprising the following steps:

a—preparation of the core-shell dye microparticles dispersed in water;

b—addition of the preparation obtained in step a) in an aqueous ink composition;

c—addition of the coloring agent;

d—recovery of the non-thermochromic color changing aqueous writing ink obtained in step c).

Step a) of the process according to the present disclosure can be any micro-encapsulation process known conventionally in the art such as
any chemical process which rely on in situ formation of coating microcapsules such as interfacial polymerization or polycondensation, these processes being the preferred ones;
any physicochemical process, such as phase separation or coacervation, by solvent evaporation-extraction, by thermal gelation of emulsions (hot-melt) or
any mechanical process, such as spray-drying, droplets gelation or freezing, spray-coating.

More specifically the resin precursor used in step a) is soluble in water. More specifically the core-shell dye microparticles in step a) are obtained by the use of in situ polymerization, in particular from melamine resin.

At the end of step a), slurry of the microparticles dispersed in water can be obtained.

More specifically the process according to the present disclosure comprises before step b) a step a1) of preparation of an aqueous ink composition. This step a1) can be carried out by any method known by the one skilled in the art such as the mixing of the ink ingredients, in particular under agitation, even more specifically under heating, for example at 30° C.

Step b) of the process according to the present disclosure can be carried out under heating, more specifically at a temperature between 25 and 40° C., in particular at 30° C.

It is more specifically carried out under agitation.

The ink obtained in step b) can be homogenized during a certain period of time, more specifically several hours, in particular at least 3 hours.

Another object of the present disclosure is a process for writing on a porous substrate, comprising the step of applying an ink composition according to the disclosure to a porous substrate, more specifically comprising cellulosic fibers, and even more specifically chosen in the group consisting of paper, printer paper or cardboard. The process for writing on a porous substrate may further comprise a step of changing the initial color (first color) of the writing to another color (second color) by peeling, more specifically by peeling with a rubber, more specifically the first and second colors being different which means that they can be distinguished from each other by the human eye.

### EXAMPLE

The present disclosure will be understood more clearly in the light of the example which follows, which is given in a non-limiting way.

### Example 1: Preparation of a Non-Thermochromic Color Changing Aqueous Writing Ink According to the Invention

### a) Preparation of the Core-Shell Dye Microparticles According to the Invention:

10 parts of Solvent yellow 36 dye are added to 90 parts of octadecane-1-ol at 70° C. until complete dissolution.

3.6 parts of an aqueous solution of anhydride maleic/methylvinylether copolymer (33% by weight of copolymer in water) are neutralized with 4.4 parts of aqueous solution of sodium hydroxide (1M). This solution is diluted with 46.4 parts of water. This solution is homogenized with high speed homogenizer at a minimum speed of 5 m·s⁻¹. 27.8 parts of the previous mix with dye and octadecane-1-ol solution are added to the reaction mixture. This reaction mixture is emulsified at 80° C. for 30 minutes.

17.8 parts of a melamine/formaldehyde pre-polymer solution (50% weight solution of pre-polymer in water) are added dropwise to the reaction mixture. The reaction mixture is homogenized at 5 m·s⁻¹ at 90° C. for 4 hours. A slurry (dispersion of microcapsules in water) containing approximatively 35% by weight of microcapsules, is obtained. The D50 mean in intensity particle size diameter was measured as being 5.8 μm via dynamic light scattering (Malvern Mastersizer 3000E).

### b) Red to Yellow Ink Preparation Protocol:

10.5 parts of glycerin are heated at 30° C., 0.2 parts of benzotriazole, 0.1 parts of 1,2-benzisothiazolin-3-one aqueous solution (containing 2.5 weight % 1,2-benzisothiazolin-3-one in water), 0.1 parts of 2-methyl-4-isothiazolin-3-one aqueous solution (containing 2.5 weight % 2-methyl-4-isothiazolin-3-one in water) are added. After dissolution, 0.5 parts of xanthan gum are added. After dispersion of the xanthan gum, 28.35 parts of demineralized water is added slowly. After complete addition of the demineralized water, the previously made slurry (60 parts) is slowly added. Then, 0.25 parts of coloring agent: dye Acid red 52 is added in the mixture. The mixture is homogenized 3 hours at 30° C.

This ink is degassed under reduced pressure. The ink obtained is a gel ink for ball point pen.

The color-change of the ink thus obtained is evaluated visually.

Protocol:
1. A writing mark is realized with the ink as prepared above using a ball point pen on standard paper ISO12575. This is the color 1.
2. The writing mark is erased with a rubber (BIC Plast-Office) a few minutes after writing. Color 2 appears.

1. Non-thermochromic irreversible color changing aqueous writing ink comprising core-shell dye microparticles and a coloring agent, wherein the core of said core-shell dye microparticles comprises an organic solvent immiscible with water and at least one dye soluble in said organic solvent and the shell includes a resin component.

2. Non-thermochromic irreversible color changing aqueous writing ink according to claim 1, wherein the core-shell dye microparticles have a mean diameter in intensity D50 measured by dynamic light scattering in the range 2-20 μm.

3. Non-thermochromic irreversible color changing aqueous writing ink according to any one of claim 1, wherein the core-shell dye microparticles are microspheres.

4. Non-thermochromic irreversible color changing aqueous writing ink according to claim 1, wherein the amount of the core-shell dye microparticles in the ink is within the range 5-40 weight % based on the total weight of the ink.

5. Non-thermochromic irreversible color changing aqueous writing ink according to claim 1, wherein the organic solvent of the microparticle's core is immiscible with water and selected in the group consisting of petroleum solvents, esters, ethers, aryl ethers and arylalkyl ethers glycol ethers, fatty alcohols, amines, terpenes, naphthenic solvent, halogenated solvents, chlorinated paraffin and monochlorobenzene, ketones, cottonseed oil, groundnut oil, silicone oil, tricresyl phosphate, partially hydrogenated terphenyls, alkylated diphenyls and mixture thereof.

6. Non-thermochromic irreversible color changing aqueous writing ink according to claim 1, wherein the organic solvent content of the microparticle's core is in the range 75-98 weight % based on the total weight of the microparticle's core.

7. Non-thermochromic irreversible color changing aqueous writing ink according to claim 1, wherein the dye content of the microparticle's core is in the range 2-25 weight % based on the total weight of the microparticle's core.

8. Non-thermochromic irreversible color changing aqueous writing ink according to claim 1, wherein the resin of the shell's microparticle is selected in the group consisting of polymer of urethane resin, melamine resin, urea resin, benzoguanamine resin, phenol resin, epoxy resin, natural polymers.

9. Non-thermochromic irreversible color changing aqueous writing ink according to claim 1, wherein the coloring agent is a dye or a pigment.

10. Non-thermochromic irreversible color changing aqueous writing ink according to claim 1, wherein the coloring agent content is in the range 0.01-30 weight %, based on the total weight of the ink.

11. Non-thermochromic irreversible color changing aqueous writing ink according to claim 1, wherein the ink comprises a rheology modifying agent.

12. Non-thermochromic irreversible color changing aqueous writing ink according to claim 1, wherein the ink contains other additives.

13. Non-thermochromic irreversible color changing aqueous writing ink according to claim 1, wherein the ink is color changing by peeling.

14. Writing instrument containing the non-thermochromic irreversible color changing aqueous writing ink according to claim 1.

15. Process of preparation of the non-thermochromic irreversible color changing aqueous writing ink according to claim 1, comprising the following steps:
a—preparation of the core-shell dye microparticles dispersed in water;
b—addition of the preparation obtained in step a) in an aqueous ink composition;
c—addition of the coloring agent; and
d—recovery of the non-thermochromic irreversible color changing aqueous writing ink obtained in step c).

16. Non-thermochromic irreversible color changing aqueous writing ink according to claim 1, wherein the core-shell dye microparticles have a mean diameter in intensity D50 measured by dynamic light scattering in the range 4-20 μm.

17. Erasable aqueous non-thermochromic writing ink according to claim 1, wherein the ink further contains at least a water miscible solvent.

18. Erasable aqueous non-thermochromic writing ink according to claim 17, wherein the water miscible solvent is present in an amount ranging from 5 to 50 weight %, relative to the total weight of the aqueous ink.

19. Erasable aqueous non-thermochromic writing ink according to claim 1, wherein the aqueous ink composition is not an emulsion.

20. Erasable aqueous non-thermochromic writing ink according to claim 1, wherein the composition is essentially free of a solvent that is immiscible with water.
